(19) United States
(12) Patent Application Publication
(10) Pub. No.: US 2020/0136108 A1
(43) Pub. Date: Apr. 30, 2020

(54) ENERGY STORAGE APPARATUS

(71) Applicant: GS Yuasa International Ltd., Kyoto-shi (JP)

(72) Inventor: Masamitsu TONONISHI, Kyoto-shi, Kyoto (JP)

(21) Appl. No.: 16/621,169

(22) PCT Filed: Jun. 5, 2018
(86) PCT No.: PCT/JP2018/021504

§ 371 Date: Dec. 10, 2019

(30) Foreign Application Priority Data
Jun. 12, 2017 (JP) 2017-115229

(51) Int. Cl. H01M 2/10; H01G 11/12; H01G 11/78

(52) U.S. Cl. CPC H01M 2/1077; H01G 11/78; H01G 11/12

(57) ABSTRACT

An energy storage apparatus includes: a plurality of energy storage devices stacked and arranged in a first direction; end-plates, disposed at both ends in the first direction of the plurality of energy storage devices; and a restraint element that restrains positions in the first direction of the plurality of energy storage devices. The restraint element includes a porous member having a plurality of cylindrical portions that are arranged two-dimensionally in the first direction and a second direction intersecting with the first direction. An axis L of each of the cylindrical portions of the porous member extends in a third direction intersecting with the first direction and the second direction.

### TECHNICAL FIELD

The present invention relates to an energy storage apparatus.

### BACKGROUND ART

Patent Document 1 discloses an energy storage apparatus including; a plurality of energy storage devices stacked and arranged in one direction; end-plates disposed at both ends in the stacking direction of the energy storage devices; and a restraint member fixed to these end-plates. In this energy storage apparatus, the strength in the stacking direction of the energy storage devices is improved by the restraint member restraining the positions in the stacking direction of the energy storage devices. Further, an opening is provided in a part of the restraint member, and a rib is provided around the opening. Thereby, while the weight of the restraint member is reduced, a decrease in rigidity of the restraint member is prevented.

### PRIOR ART DOCUMENT

### Patent Document

Patent Document 1; JP-A-2017-59501

### SUMMARY OF THE INVENTION

### Problems to be Solved by the Invention

In the energy storage apparatus of Patent Document 1, when an external force is applied in a direction intersecting with the stacking direction of the energy storage devices, the restraint member is deformed and a load is also applied to the energy storage devices, which may damage the energy storage devices. Therefore, in the energy storage apparatus of Patent Document 1, there is room for improvement in strength in the direction intersecting with the stacking direction of the energy storage devices.

An object of the present invention is to provide an energy storage apparatus that can prevent damage to an energy storage device due to application of an external force.

### Means for Solving the Problems

The present invention provides an energy storage apparatus including: a plurality of energy storage devices stacked and arranged in a first direction; an end-plate disposed at each end in the first direction of the plurality of energy storage devices; and a restraint element that is fixed to the end-plate and restrains positions in the first direction of the plurality of energy storage devices. The restraint element includes a porous member that has a plurality of cylindrical portions arranged two-dimensionally in the first direction and a second direction intersecting with the first direction and is disposed such that an axis of each of the cylindrical portions extends in a third direction intersecting with the first direction and the second directions.

A porous member made up of a plurality of cylindrical portions has very strong rigidity in the third direction in which the axis of the cylindrical portion extends. Thus, by disposing the porous member along the first direction in which the energy storage devices are stacked, it is possible to effectively improve the pressure-breakage resistance of the energy storage device against an external load. Moreover, the porous member is lightweight since being made up of the plurality of cylindrical portions. Hence it is possible to achieve both the reduction in weight and the improvement in strength of the energy storage apparatus including the plurality of energy storage devices.

The energy storage device may be a flat battery including an electrode assembly and a case in which the electrode assembly is accommodated, the case may have a pair of long side-walls extending in the second direction and the third direction, and a pair of short side-walls extending in the first direction and the second direction and each having a dimension in the first direction shorter than a dimension in the third direction of each of the long side-walls, the restraint element may have a fixing portion fixed to the end-plate, and the porous member may be disposed between at least a pair of the fixing portions.

Lithium ion batteries have the advantage of being lighter than lead-acid batteries, but are required to have pressure-breakage resistance from the viewpoint of safety. In recent years, energy storage apparatuses mounted on vehicles including automobiles are strongly required to improve safety, and accordingly, the demand for performance of pressure-breakage resistance is increasing. The term “pressure-breakage resistance” as used herein refers to resistance to breakage against an external force in which deformation is extremely small even when pressure is applied instantaneously or continuously. The present invention has been made to realize such a new demand.

The short side-walls are disposed to be arranged in the first direction, and the porous member is disposed on the short side-wall side. Therefore, the total length of the porous member can be shortened compared to a case where the long side-walls are disposed to be arranged in the first direction and the porous member is disposed on the long side-wall side. As a result, it is possible to achieve both the reduction in weight and the improvement in strength of the energy storage apparatus.

The cylindrical portion of the porous member may have such a size that one or more of the cylindrical portions are disposed on the short side-wall of one of the cases in the first direction.

Since one or more cylindrical portions face the short side-wall of one energy storage device, the strength in the third direction can be improved reliably.

The energy storage apparatus may further includes: an outer case that accommodates the plurality of energy storage devices; an electrical component disposed between at least one of a pair of the end-plates and an opposedly facing surface of the outer case; and a second porous member disposed between the electrical component and the opposedly facing surface of the outer case, having a plurality of cylindrical portions arranged two-dimensionally in the second direction and the third direction, and disposed such that an axis of each of the cylindrical portions extends in the first direction.

The second porous member can perform the protection of the energy storage devices, which has depended on the rigidity of the outer case itself and the buffer space between the outer case and the end-plate. It is thereby possible to effectively improve the pressure-breakage resistance of the energy storage device against a load from the outside of the outer case. Further, space is formed between the end-plate and the second porous member, and an electrical component such as a relay or a fuse is disposed in this space, so that the electrical component can also be protected by the second porous member.

The fixing portion of the restraint element may have a protrusion that protrudes from the end-plate toward the opposedly facing surface of the outer case, and the second porous member is fixed to the protrusion.

The second porous member can be fixed without using an additional component, and space for disposing the electrical component can be ensured.

The cylindrical portion of the porous member may have a regular hexagonal cross-section.

Since the porous member is not a simple lattice structure but a honeycomb structure, not only the strength in the third direction in which the axis of the cylindrical portion extends but also the strength in the first direction and the second direction can be improved.

The energy storage device may be a flat battery including an electrode assembly that has an electrode sheet, and a case in which the electrode assembly is accommodated, and the electrode sheet may have a plane extending in the second direction and the third direction.

Since the porous member is provided with respect to the electrode assembly in which the electrode sheet has a plane extending in the second direction and the third direction, it is possible to prevent the deformation of the end portion of the electrode sheet that causes a short circuit.

### Advantages of the Invention

In the energy storage apparatus of the present invention, by disposing the porous member along the first direction in which the energy storage devices are stacked, the pressure-breakage resistance of the energy storage device against an external load can be improved effectively. In addition, since the porous member is lightweight, it is possible to achieve both the reduction in weight and the improvement in strength of the energy storage apparatus.

### BRIEF DESCRIPTION OF THE DRAWINGS

FIG. 1 is an exploded perspective view of an energy storage apparatus according to a first embodiment.

FIG. 2 is a cross-sectional view of the energy storage apparatus according to the first embodiment, in which a lid body has been removed.

FIG. 3 is an exploded perspective view of an energy storage module according to the first embodiment.

FIG. 4 is an exploded perspective view of a battery cell.

FIG. 5 is an exploded perspective view of a porous member.

FIG. 6 is a side view showing a battery cell and the porous member.

FIG. 7 is a perspective view showing a comparative example of a restraint plate.

FIG. 8 is an exploded perspective view of an energy storage apparatus according to a second embodiment.

FIG. 9 is a cross-sectional view of the energy storage apparatus according to the second embodiment, in which a lid body has been removed.

FIG. 10 is an exploded perspective view of an energy storage module according to a second embodiment.

FIG. 11 is an exploded perspective view of an energy storage apparatus according to a third embodiment.

FIG. 12 is a cross-sectional view of the energy storage apparatus according to the third embodiment, in which a lid body has been removed.

FIG. 13 is an exploded perspective view of an energy storage module according to the third embodiment.

FIG. 14 is an exploded perspective view of an energy storage apparatus according to a modification.

### MODES FOR CARRYING OUT THE INVENTION

Hereinafter, embodiments of the present invention will be described with reference to the drawings.

### First Embodiment

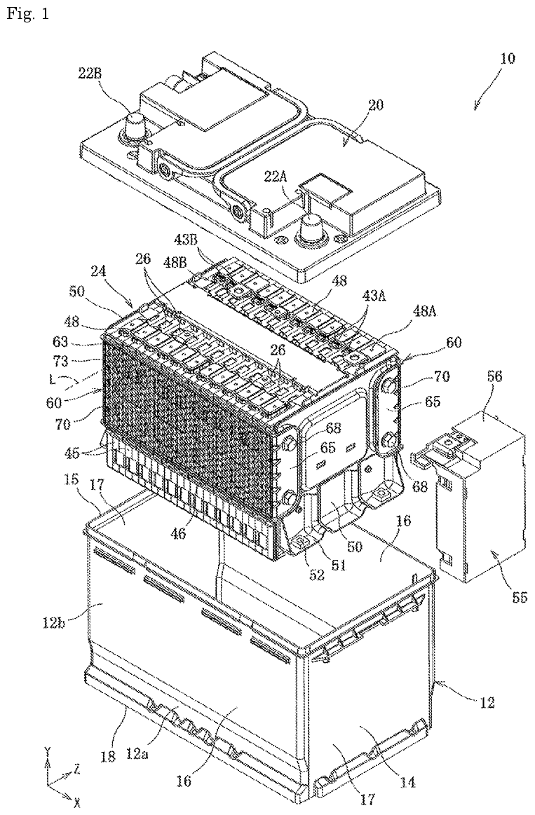

FIGS. 1 to 6 show an energy storage apparatus 10 according to a first embodiment of the present invention. The energy storage apparatus 10 includes an outer case 12 and a battery module 24 accommodated inside the outer case 12. The battery module 24 includes a plurality of (in the present embodiment, twelve) battery cells 26 as energy storage devices. In the present embodiment, a restraint element 60 improves the strength of the outer case 12 against an external load and effectively prevents the damage of the battery cell 26 due to application of an external force.

In the following description, the first direction, which is the longitudinal direction of the outer case 12 and the short direction of the battery cell 26, is referred to as an X direction. The second direction which is the height direction of the outer case 12 and the battery cell 26 is referred to as a Y direction. The third direction, which is the short direction of the outer case 12 and the longitudinal direction of the battery cell 26, is referred to as a Z direction.

### (Outline of Energy Storage Apparatus)

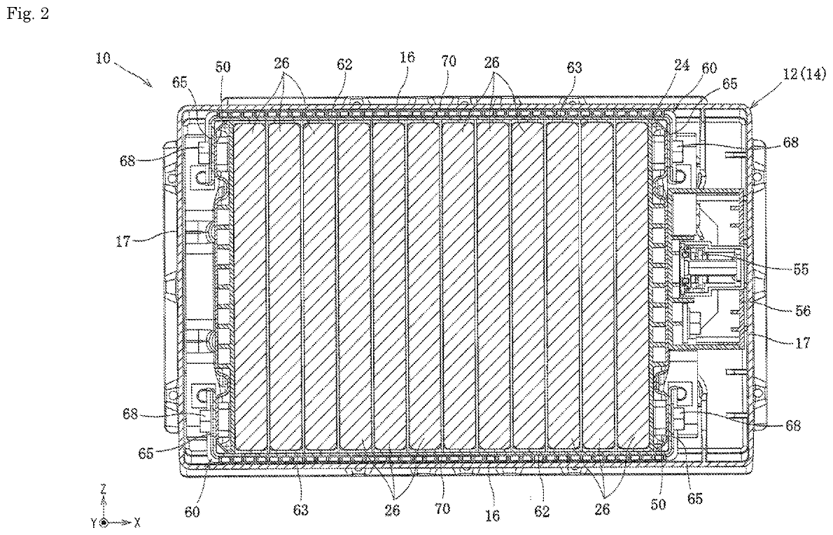

As shown in FIGS. 1 and 2, the outer case 12 includes a resin-made main body 14 having an opening 15 on one surface (upper surface in the Y direction), and a lid body 20 that closes the opening 15 of the main body 14. The main body 14 is a box including a pair of long side-walls 16, 16 extending along an X-Y plane, a pair of short side-walls 17, 17 extending along a Y-Z plane, and a bottom wall 18 extending along a Z-X plane. The dimension in the Z direction of the short side-wall 17 is shorter than the dimension in the X direction of the long side-wall 16. The lid body 20 is liquid-tightly attached to the opening 15 of the main body 14. The lid body 20 includes a positive external terminal 22A and a negative external terminal 22B that are electrically connected to the battery module 24.

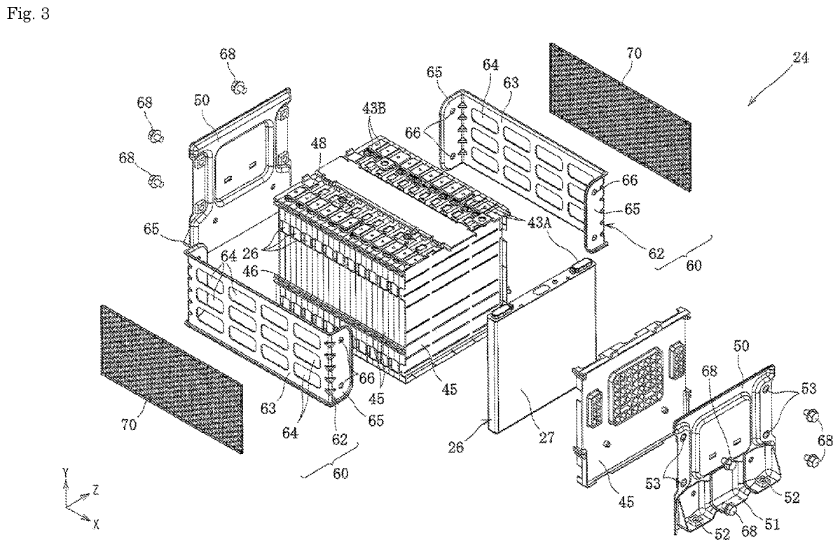

Referring to FIG. 3, the battery module 24 is obtained by stacking and arranging the battery cells 26 via resin-made spacers 45 along the X direction. As the battery cell 26, a nonaqueous electrolyte secondary battery such as a lithium ion battery is used. However, in addition to the lithium ion battery, various battery cells 26 including a capacitor can be applied.

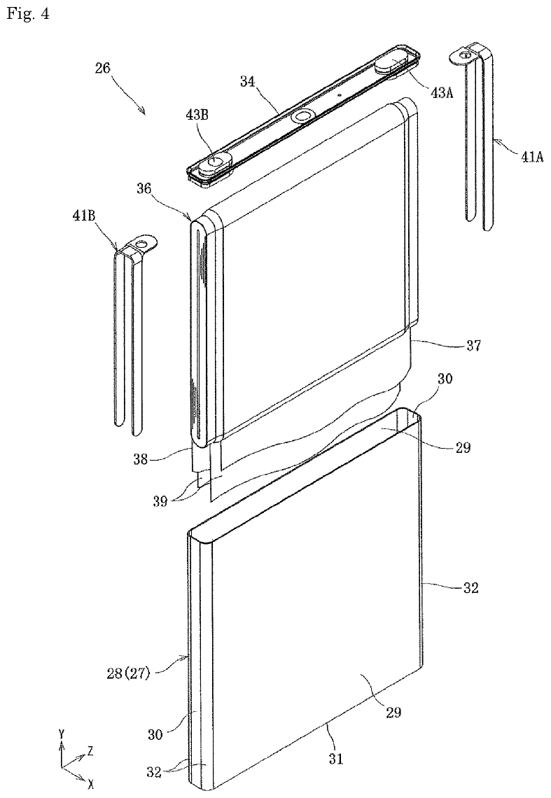

As shown in FIG. 4, each individual battery cell 26 includes a case 27, an electrode assembly 36, current collectors 41A, 41B, and terminals 43A, 43B.

The case 27 includes a flat case body 28 having an opening on one surface (upper surface in the Y direction), and a lid 34 that closes the opening of the case body 28. The case body 28 is a box including a pair of long side-walls 29, 29 extending along the Y-Z plane, a pair of short side-walls 30, 30 extending along the X-Y plane, and a bottom wall 31 extending along the Z-X plane. The dimension in the X direction of the short side-wall 30 is shorter than the dimension in the Z direction of the long side-wall 29. The lid 34 is liquid-tightly attached to the opening of the case body 28. Both the case body 28 and the lid 34 are made of aluminum or stainless steel and are sealed by welding.

The electrode assembly 36 includes a positive electrode sheet 37 having a plane extending in the Y direction and the Z direction, a negative electrode sheet 38, and two separators 39, 39, and is a flat wound body wound around an axis in a state where these are stacked. The electrode assembly 36 is accommodated in the case 27 in an orientation in which a winding shaft is along the longitudinal direction (Z direction) of the case 27. Thereby, the electrode assembly 36 is accommodated in the outer case 12 in a state where the electrode sheets 37, 38 and the separators 39, 39 are laminated in the X direction.

The positive electrode current collector 41A is disposed at an end portion, from which the positive electrode sheet 37 protrudes, and is electrically connected to the positive electrode sheet 37. The negative electrode current collector 41B is disposed at an end portion from which the negative electrode sheet 38 protrudes, and is electrically connected to the negative electrode sheet 38. The positive electrode current collector 41A may be formed of a metal such as aluminum, and the negative electrode current collector 41B may be formed of a metal such as copper.

The positive terminal 43A is provided on one end side in the Z direction of the lid 34, and the negative terminal 43B is provided on the other end side in the Z direction of the lid 34. The positive terminal 43A is electrically connected to the positive electrode current collector 41A, and is electrically connected to the electrode assembly 36 via the positive electrode current collector 41A. The negative terminal 43B is electrically connected to the negative electrode current collector 41B, and is electrically connected to the electrode assembly 36 via the negative electrode current collector 41B.

As shown in FIGS. 1 and 3, a bus bar 48 as a conductive member is connected to the positive terminal 43A and the negative terminal 43B of the adjacent battery cells 26, 26 by welding. When the connection is parallel connection, the positive terminals 43A, 43A of the prescribed battery cells 26, 26 are connected electrically, and the negative terminals 43B, 43B of the prescribed battery cells 26, 26 are connected electrically. When the connection is series connection, the positive terminal 43A of the prescribed battery cell 26 and the negative terminal 43B of the prescribed battery cell 26 are connected electrically.

FIGS. 1 to 3 show an example of an aspect in which three battery cells 26 out of twelve battery cells 26 are connected in parallel, and four sets of three battery cells 26 connected in parallel are connected in series. In a first set of battery cells 26 located at the right end in FIG. 1, a bus bar 48A connected to the positive terminal 43A is electrically connected to the positive external terminal 22A of the lid body 20. In a fourth set of battery cells 26 located at the left end in FIG. 1, a bus bar 48B connected to the negative terminal 43B is electrically connected to the negative external terminal 22B of the lid body 20. Thereby, each battery cell 26 can be charged and discharged with electricity via the positive external terminal 22A and the negative external terminal 22B.

The individual battery cells 26 may expand in the X direction. The expansion of the battery cell 26 is caused by an unintended abnormality in which, for example, the electrolyte solution having filled the case 27 is decomposed due to overcharge or the like, and gas is generated in the case 27. When the battery cell 26 expands, the dimension in the X direction of the battery cell 26 becomes larger than the initial size, and the outer case 12 is also deformed by the internal pressure.

Further, the lithium ion battery as the battery cell 26 has an advantage of being lightweight compared to the lead-acid battery. However, the lithium ion battery is required to have pressure-breakage resistance from the viewpoint of safety. In recent years, energy storage apparatuses 10 mounted on vehicles including automobiles have been strongly required to improve safety and increasingly required to have performance of pressure-breakage resistance, with which the deformation is extremely less likely to occur even when pressure is applied instantaneously or continuously (resistance to breakage against an external force).

In the battery module 24 of the present embodiment, the restraint element 60 is disposed to prevent the expansion of the battery cell 26 and ensure the pressure-breakage resistance against an external force to the outer case 12, thereby preventing the battery cell 26 from being damaged.

### (Details of Restraint Elements)

As shown in FIGS. 1 to 3, end-plates 50, 50 are disposed at both ends of the battery module 24 in the X direction. The restraint element 60 is fixed to the end-plates 50, 50, and the restraint element 60 restrains the positions in the X direction of the plurality of battery cells 26.

The end-plate 50 is disposed along the Y-Z plane so as to cover the long side-wall 29 of the battery cells 26, 26 at both ends. At the lower end in the Y direction of the end-plate 50, a fixing portion 51 extending along the Z-X plane is provided. The fixing portion 51 includes a pair of first bolt holes 52, 52 and is fixed to the bottom wall 18 of the outer case 12 by bolts (not shown). Thereby, the battery module 24 is held at a prescribed position in the X direction in the outer case 12. Further, a second bolt hole 53 for fixing the restraint element 60 is provided on each side in the Z direction of the end-plate 50. In the present embodiment, the spacer 45 is also disposed between the end-plate 50 and the battery cell 26.

On one of a pair of the end-plates 50, 50, an electrical component 55 is disposed. The electrical component 55 may be a fuse or a relay electrically connected to the bus bar 48. The electrical component 55 is fixed to the end-plate 50 by bolting while being accommodated in a dedicated protective case 56.

The restraint element 60 includes a metal restraint plate 62 and a porous member 70 having many cylindrical portions 73. As shown most clearly in FIG. 1, the restraint element 60 is disposed on a step 46 provided in the spacer 45. The step 46 protrudes outward in the Z direction and is located inside the narrowed portion 12a of the outer case 12. The restraint plate 62 is disposed inside the expanded portion 12b that expands on the narrowed portion 12a of the outer case 12.

The restraint plate 62 includes a restraint plate body 63 and a pair of fixing portions 65, 65, and is obtained by integrally forming these by press working.

The restraint plate body 63 extends along the X-Y plane and has a total length extending from one end to the other end in the X direction of the battery module 24. The restraint plate body 63 is provided with a plurality of (twelve in three rows and four columns in the present embodiment) openings 64.

The fixing portion 65 is bent with respect to the restraint plate body 63 so as to extend along the Y-Z plane. The fixing portion 65 is provided with an insertion hole 66 that coincides with the second bolt hole 53 of the end-plate 50. The restraint plate 62 is fixed to the end-plate 50 by disposing the fixing portion 65 outside the end-plate 50 in the X direction and tightening a bolt 68 in the second bolt hole 53 through the insertion hole 66.

The configuration in which the end-plate 50 and the restraint plate 62 configured as thus described are disposed on the battery module 24 is also used in a conventional energy storage apparatus. In the battery module 24, since the position in the X direction of each individual battery cell 26 is restrained by the restraint plate 62, it is possible to effectively prevent the outward expansion of the battery cells 26 in the X direction. Further, the X direction of the battery module 24 is the stacking direction of the battery cells 26 and the stacking direction of the electrode sheets 37, 38. Therefore, the strength against the external force in the X direction applied to the battery module 24 is high.

However, the restraint plate 62 is weak against an external force in the Z direction intersecting with the restraint plate body 63, and there is a limit to improving the rigidity by forming ribs. The deformation of the restraint plate 62 due to an external force in the Z direction is the largest in the central portion in the X direction. In addition, when the restraint plate 62 is deformed, an external force is also applied to the individual battery cells 26, so that there is a possibility that the battery cell 26 in the central portion may particularly be damaged. The damage of the battery cell 26 at this time includes that the joint portion between the case body 28 and the lid 34 is deformed and the welding is peeled off.

The porous member 70 improves the pressure-breakage resistance against an external force in the Z direction applied to the outer case 12, and protects the battery cell 26 inside. The porous member 70 has a flat plate shape extending along the X-Y plane and is fixed facing the restraint plate body 63 so as to be adjacent to the restraint plate 62. The dimension in the X direction of the porous member 70 is the entire length located between the pair of fixing portions 65, 65 of the restraint plate 62. The porous member 70 is fixed to the restraint plate body 63 by adhering means such as an epoxy adhesive, a blind rivet, or a screw. The adhering means can be changed as necessary so long as being able to withstand the restraint of the battery module 24.

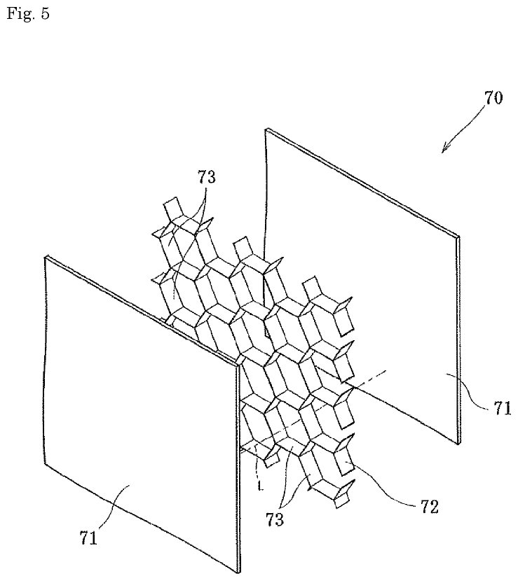

Referring to FIG. 5, the porous member 70 is disposed by placing a porous core material 72 between a pair of sheet-like surface materials 71, 71. The surface material 71 is not provided with any through holes or the like. The core material 72 has a configuration in which cylindrical portions 73 each having a hollow portion in a regular hexagonal cross-section are arranged two-dimensionally in the X direction and the Y direction. The porous member 70 is formed by adhesion of the surface material 71 to each side of the core material 72 in the Z direction. The surface material 71 and the core material 72 may be made of metal (e.g., aluminum) or may be made of hard resin. However, the surface material 71 may be made of resin and the core material 72 may be made of metal, or the surface material 71 may be made of metal and the core material 72 may be made of resin.

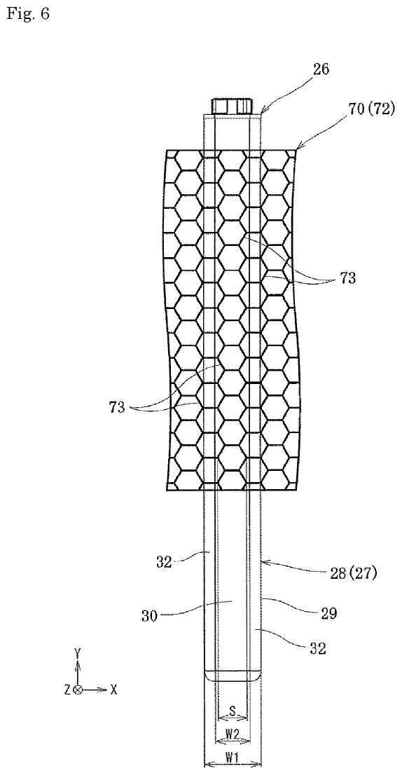

Referring to FIG. 6, at least one cylindrical portion 73 has such a size that one or more thereof is disposed on the short side-wall 30 in the X direction of one case 27. That is, a dimension S in the X direction perpendicular to an axis L of the cylindrical portion 73 is smaller than a width W1 between the pair of long side-walls 29, 29 and is smaller than a substantial width W2 in the X direction of the short side-wall 30 which excludes chamfered portions 32 between the long side-walls 29 and the short side-wall 30. Thereby, among many cylindrical portions 73 arranged in the vertical and horizontal directions, one or more of the plurality of cylindrical portions 73 arranged in the X direction in the same row are set so as to intersect with the short side-wall 30. Further, among many cylindrical portions 73 arranged in the vertical and horizontal directions, a plurality of cylindrical portions 73 arranged in the same row in the Y direction are set so as to intersect with the short side-wall 30. In many cases, the axis L of one cylindrical portion 73 and the center in the X direction of the short side-wall 30 do not coincide with each other. That is, that one or more cylindrical portions 73 are disposed on the short side-wall 30 means that the cylindrical portions 73 in a quantity corresponding to one or more thereof are disposed on the short side-wall 30.

The porous member 70 has very strong rigidity in the direction in which the axis L of the cylindrical portion 73 extends. Therefore, by disposing the porous member 70 in the battery module 24 (restraint plate body 63) in an orientation in which the axis L of the cylindrical portion 73 extends in the Z direction, it is possible to effectively improve the pressure-breakage resistance of the battery cell 26 against a load from the outside of the outer case 12. That is, even when pressure is applied to the outer case 12 instantaneously or continuously, the deformation of the restraint element 60 can be prevented, and the breakage of the battery cell 26 inside due to the pressure can also be prevented effectively. Further, since the cylindrical portion 73 has a honeycomb structure rather than a simple lattice structure, not only the strength in the Z direction in which the axis L of the cylindrical portion 73 extends, but also the strength in the X direction and the Y direction can be improved. Moreover, the porous member 70 is lightweight since being made up of the plurality of cylindrical portions. Hence it is possible to achieve both the reduction in weight and the improvement in strength of the energy storage apparatus 10 including the plurality of battery cells 26.

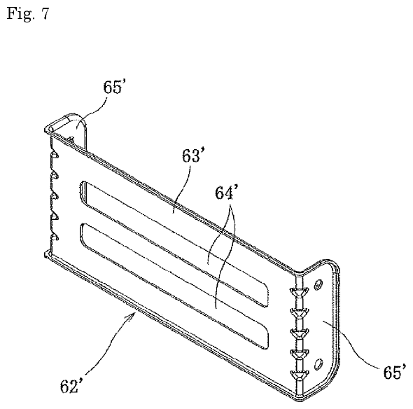

FIG. 7 shows a restraint plate 62′ of a comparative example (conventional example). The restraint plate 62 of the first embodiment and the restraint plate 62′ of the comparative example are different in the total opening area of the openings 64, 64′, and the total opening area of the example restraint plate 62′ is narrower than the total opening area of the restraint plate 62 of the first embodiment. The total weight of the restraint element 60 of the first embodiment in which the porous member 70 is added to the restraint plate 62 is 220 g. On the other hand, the weight of the restraint plate 62′ of the comparative example is 210 g. That is, the total weight of the restraint element 60 of the first embodiment and the weight of the restraint plate 62′ of the comparative example are substantially the same.

When a load of 150 kN was applied in the Z direction to the restraint plate body 63′ (the total length in the X direction was 200 mm) of the restraint plate 62′ of the comparative example, the deformation amount of the restraint plate body 63′ was about 70 mm. In contrast, when a load of 150 kN was applied in the Z direction to the restraint element 60 of the first embodiment, the deformation amount of the restraint plate body 63 was about 15 mm. That is, the weight of the restraint element 60 of the first embodiment is increased by 5% from the restraint plate 62′ of the comparative example, but the deformation amount of the restraint element 60 of the first embodiment can be reduced by about 77% from the restraint plate 62 of the comparative example. As described above, the restraint element 60 using the porous member 70 can effectively improve the pressure-breakage resistance without excessively increasing the weight. In addition, the total weight of the restraint element 60 can be reduced by adjusting the opening area of the opening 64 of the restraint plate 62 and/or the size of the cylindrical portion 73 of the porous member 70.

In the energy storage apparatus 10 of the present embodiment, the short side-walls 30 are disposed to be arranged in the X direction, and the porous member 70 is disposed on the short side-wall 30 side. Therefore, the total length of the porous member 70 can be shortened compared to a case where the long side-walls are disposed to be arranged in the X direction and the porous member is disposed on the long side-wall side. As a result, it is possible to achieve both the reduction in weight and the improvement in strength of the energy storage apparatus 10.

### Second Embodiment

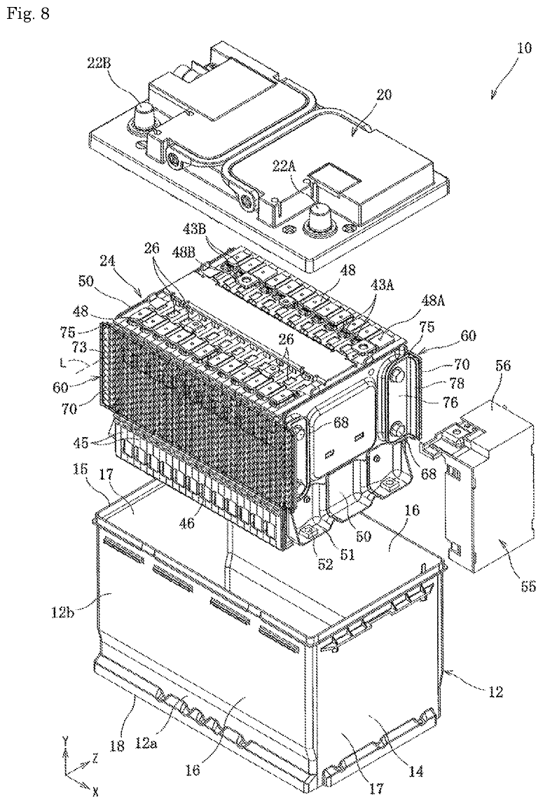

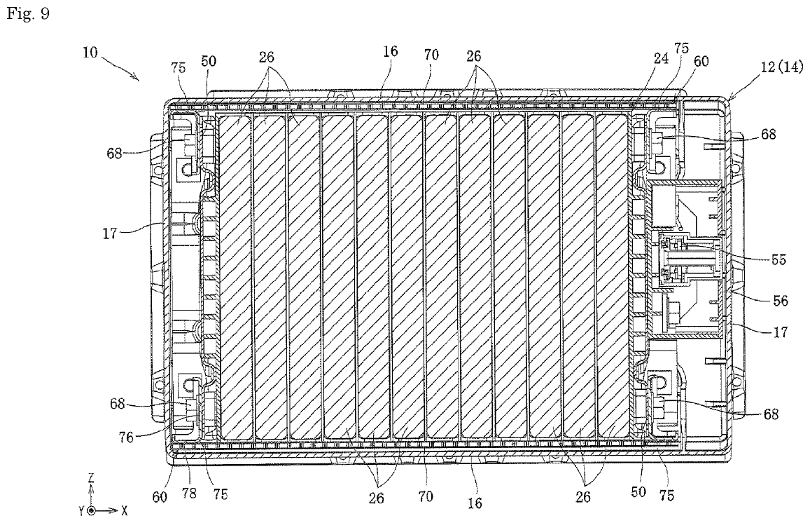

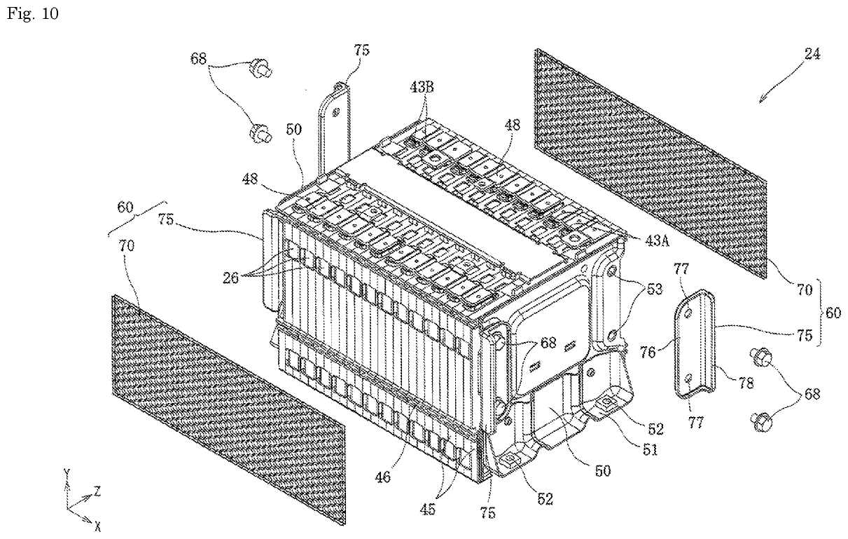

FIGS. 8 to 10 show an energy storage apparatus 10 of a second embodiment. In the second embodiment, a plurality of (four in the present embodiment) fixing members 75 are used instead of the pair of restraint plates 62, 62 of the first embodiment. That is, one restraint element 60 of the second embodiment is made up of a pair of fixing members 75, 75 and one porous member 70.

The fixing member 75 includes a fixing portion 76 for fixing to the end-plate 50 and an attachment portion (protrusion) 78 for fixing the porous member 70.

The fixing portion 76 is provided with a pair of insertion holes 77, 77 that coincide with the second bolt holes 53 of the end-plate 50.

The attachment portion 78 extends along the X-Y plane and is bent with respect to the fixing portion 76 so as to protrude toward the short side-wall (opposedly facing surface) 17 of the outer case 12. The fixing member 75 is fixed to the end-plate 50 so that the attachment portion 78 protrudes outward in the X direction with respect to the battery module 24. Further, the attachment portion 78 is disposed substantially flush with each surface in the Z direction of the battery module 24, that is, the surface of the spacer 45 extending along the X-Y plane.

The porous member 70 has a total length extending from one X-direction outer end to the other X-direction outer end of a pair of the attachment portions 78, 78 located on both sides in the X direction of the battery module 24. Similarly to the first embodiment, the porous member 70 is previously fixed to the attachment portion 78 prior to the attachment of the fixing member 75 to the battery module 24 by adhering means capable of withstanding the restraint of the battery module 24. At the time of fixing the restraint element 60 to the battery module 24, the fixing member 75 to which the porous member 70 is attached is fitted and fixed in a state where each battery cell 26 is restrained by applying a compression load.

In the energy storage apparatus 10 of the second embodiment, the pressure-breakage resistance against an external force in the Z direction can be effectively improved similarly to the first embodiment. Further, since the pair of fixing members 75 are used instead of the restraint plate 62, the weight of the restraint plate body 63 can be reduced. As a result, it is possible to achieve both the reduction in weight and the improvement in strength of the energy storage apparatus 10.

### Third Embodiment

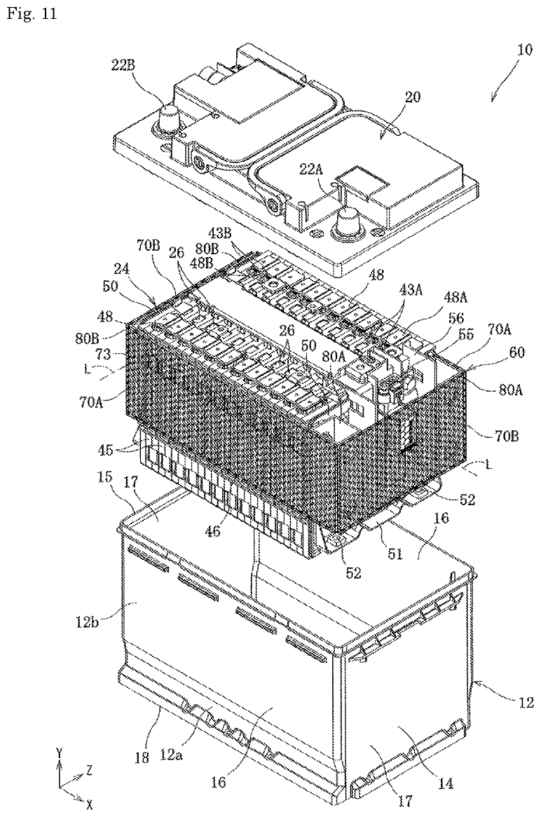

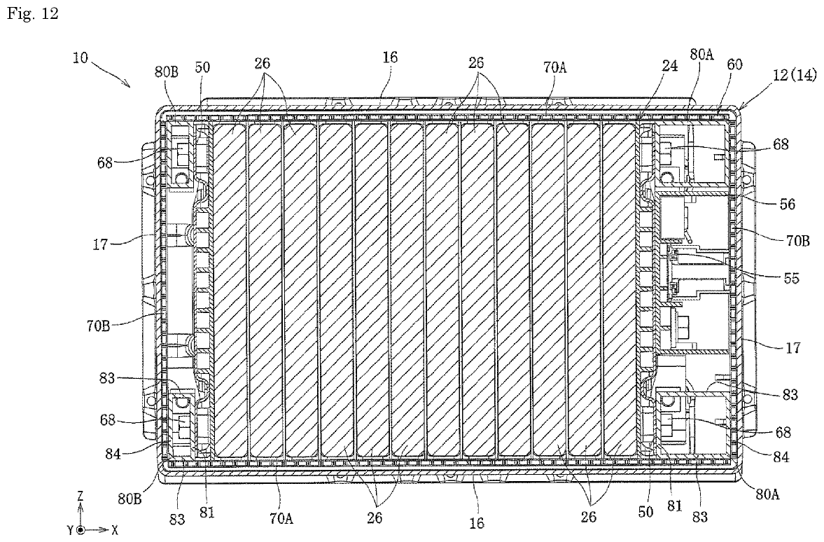

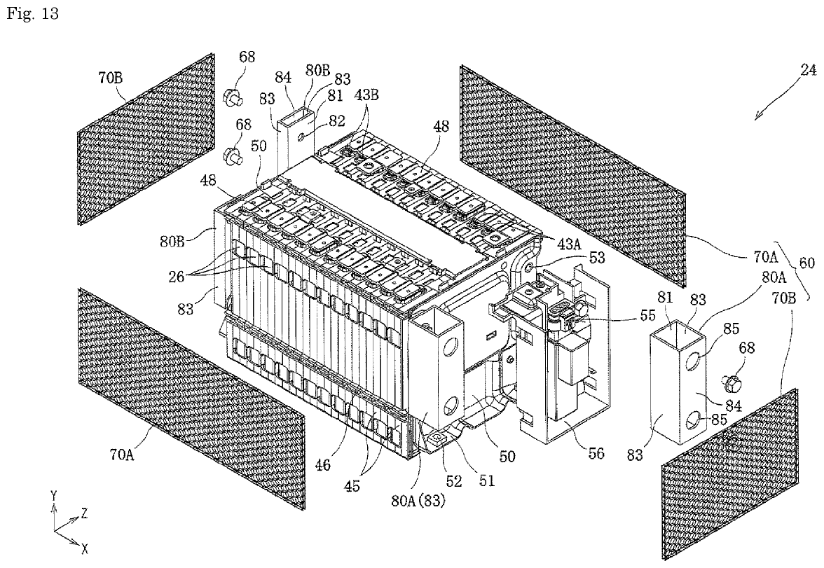

FIGS. 11 to 13 show an energy storage apparatus 10 of a third embodiment. In the third embodiment, square cylindrical fixing members 80A, 80B are used instead of the L-shaped fixing member 75 in a plan view of the second embodiment. In the third embodiment, in addition to the porous members 70A on both sides in the Z direction of the battery module 24, porous members 70B are also disposed on both sides in the X direction of the battery module 24.

The fixing members 80A, 80B include a fixing portion 81 in which an insertion hole 82 is formed. Both side portions that are continuous with the fixing portion 81 are first attachment portions 83, 83 for attaching the first porous member 70A. The first porous member 70A is fixed to the one of a pair of the first attachment portions 83, 83, which is disposed flush with the side surface in the Z direction of the battery module 24. The portion facing the fixing portion 81 is a second attachment portion 84 for attaching the second porous member 70B. That is, the pair of the first attachment portions 83, 83 and the second attachment portion 84 protrude toward the short side-wall 17 of the outer case 12 and constitute a protrusion for fixing the second porous member 70A. The second attachment portion 84 is provided with a through hole 85 for disposing the bolt 68 in an insertion hole 82 of the fixing portion 81.

The fixing members 80A, 80B are different only in that the first attachment portions 83, 83 have different total lengths in the X direction. Specifically, the total length of the first attachment portion 83 is set to a dimension in which the fixing portion 81 is close to the end-plate 50 and the second attachment portion 84 is close to the short side-wall (opposedly facing surface) 17 of the outer case 12. As described above, between the outer case 12 and the battery module 24, the electrical component 55 is disposed on one side in the X direction. The total length of the first attachment portion 83 of the fixing member 80A on the electrical component 55 side is longer than the total length of the first attachment portion 83 of the fixing member 80B on the opposite side. The X-direction outer end of the fixing member 80A is located outward from the X-direction outer end of the electrical component 55 (protective case 56).

The first porous member 70A and the second porous member 70B has a similar configuration to the first embodiment in which the core material 72 is provided between the pair of surface materials 71, 71 as shown in FIG. 5.

The first porous member 70A is disposed on the battery module 24 in an orientation where the axis of the cylindrical portion 73 extends in the Z direction. The porous member 70A has a total length extending from one X-direction outer end to the other X-direction outer end of a pair of the first attachment portions 83, 83 located on both sides in the X direction of the battery module 24. The porous member 70A is previously fixed to the first attachment portion 83 prior to the attachment of the fixing members 80A, 80B to the battery module 24 by adhering means capable of withstanding the restraint of the battery module 24. The fixing members 80A, 80B to which the first porous member 70A is attached are attached to the end-plate 50 by using the bolts 68.

The second porous member 70B is disposed on the battery module 24 in an orientation where the axis of the cylindrical portion 73 extends in the X direction. The porous member 70B has a total length extending from one Z-direction outer end to the other Z-direction outer end of a pair of the second attachment portions 84, 84 located on both sides in the Z direction of the battery module 24. The porous member 70B is fixed to the second attachment portion 84 of the fixing members 80A, 80B previously fixed to the battery module 24 by adhering means similar to that for the porous member 70A. On the fixing member 80A side, the porous member 70B is disposed between the electrical component 55 and the short side-wall 17 of the outer case 12, and on the fixing member 80B side, the porous member 70B is disposed between the end-plate 50 and the short side-wall 17.

In the energy storage apparatus 10 of the third embodiment, the first porous member 70A can improve the pressure-breakage resistance against an external force in the Z direction, and furthermore, the second porous member 70B can also improve the pressure-breakage resistance against an external force in the X direction. Hence the porous members 70A, 70B can effectively perform the protection and the battery cell 26 having depended on the rigidity of the outer case 12 itself and the buffer space between the outer case 12 and the end-plate 50.

Further, space is formed between the end-plate 50 and the second porous member 70B by the fixing member 80A, and the electrical component 55 is disposed in this space. Hence the second porous member 70B can effectively perform the protection of the electrical component 55, which has conventionally depended on the buffer space and the rigidity of the protective case 56. Furthermore, since the first porous member 70A and the second porous member 70B are fixed to the same fixing members 80A, 80B, an increase in the number of parts can be prevented.

Note that the energy storage apparatus 10 of the present invention is not limited to the configurations of the above embodiments, but various modifications can be made.

The core material 72 of the porous member 70 may have a grid shape including many cylindrical portions each forming a square cylindrical shape, and the cross-sectional shape of the cylindrical portion can be changed as necessary. Further, the configuration of the fixing member for disposing the porous member 70 can be changed as necessary.

The restraint elements are not limited to the pair of restraint elements 60 disposed one on each side in the Z direction as described above, but two or more restraint elements may be disposed on both sides or one side in the Z direction. Specifically, two or more restraint elements arranged at intervals in the Y direction may be fixed to the end-plate 50 on one side in the Z direction. In this case, the porous member 70 can be disposed adjacent to all of the two or more restraint elements arranged on one side in the Z direction, or the porous member 70 can be disposed adjacent to any of the two or more restraint elements. Specifically, the porous member 70 can be disposed adjacent to only the restraint element closest to the positive terminal 43A and the negative terminal 43A of the battery cell 26 among the two or more restraint elements disposed at intervals in the Y direction.

The electrical component 55 may be disposed on each of the end-plates 50, 50 in the pair. In addition, the electrical component 55 may also be disposed between the end portion in the Z direction of the battery module 24 and the long side-wall 16 of the outer case 12.

The electrode assembly 36 used for the battery cell 26 is not limited to a so-called “vertical winding type” in which the winding shaft is accommodated in the case 27 in an orientation along the longitudinal direction (Z direction) of the case 27, but the electrode assembly 36 may be a so-called “horizontal winding type” in which the winding shaft is accommodated in the case 27 in an orientation along the height direction (Y direction) of the case 27. Further, the electrode assembly 36 is not limited to the wound type but may be a stacked type in which a plurality of positive electrodes, negative electrodes, and separators formed in a substantially rectangular sheet shape are stacked in the short direction (X direction) of the case 27. The case for accommodating the electrode assembly may be a metal rectangular case using aluminum or stainless steel, or a pouch type in which the electrode assembly is packaged with a film-like material.

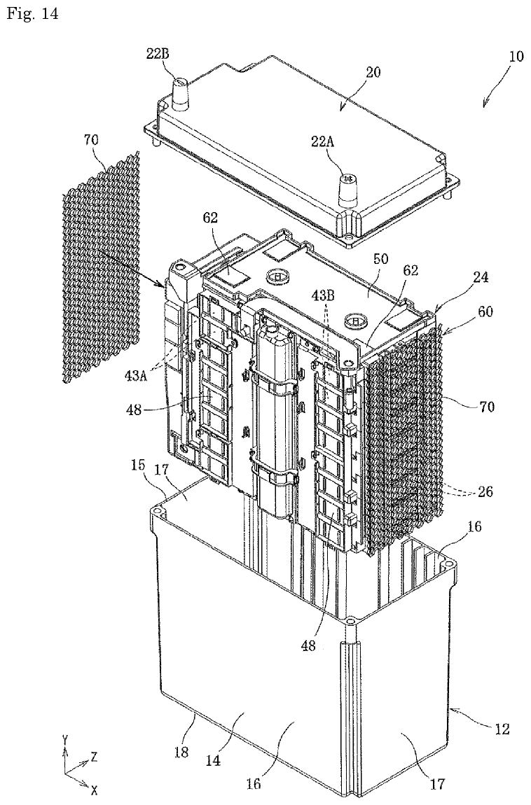

The energy storage apparatus 10 is not limited to the horizontal stacked type in which the battery cells 26 are stacked and arranged in the horizontal direction (X direction), but the energy storage apparatus 10 may be a horizontal stacked type in which the battery cells 26 are stacked and arranged in the vertical direction (Y direction) as shown in FIG. 14. Further, the porous member 70 may be disposed on the surface on which the terminals 43A, 43B of the battery cell 26 are disposed or on the surface located opposite to the terminals 43A, 43B.

In the first embodiment, the aspect of the energy storage apparatus 10 has been shown in which the porous member 70 is fixed to the restraint element 60, but the porous member 70 may not be fixed to the restraint element 60. For example, the porous member 70 is disposed facing the restraint plate body 63 so as to be adjacent to the restraint plate 62.

### DESCRIPTION OF REFERENCE SIGNS

10: energy storage apparatus
12: outer case
12a: narrowed portion
12b: expanded portion
14: main body
15: opening
16: long side-wall
17: short side-wall
18: bottom wall
20: lid body
22A: positive external terminal
22B: negative external terminal
24: battery module
26: battery cell
27: case
28: case body
29: long side-wall
30: short side-wall
31: bottom wall
32: chamfered portion
34: lid
36: electrode assembly
37: positive electrode sheet
38: negative electrode sheet
39: separator
41A: positive current collector
41B: negative current collector
43A: positive terminal
43B: negative terminal
45: spacer
46: step
48, 48A, 48B: bus bar
50: end-plate
51: fixing portion
52: first bolt hole
53: second bolt hole
55: electrical component
56: protective case
60: restraint element
62: restraint plate
63: restraint plate body
64: opening
65: fixing portion
66: insertion hole
68: bolt
70, 70A, 70B: porous member
71: surface material
72: core material
73: cylindrical portion
75: fixing member
76: fixing portion
77: insertion hole
78: attachment portion
80A, 80B: fixing member
81: fixing portion
82: insertion hole
83: first attachment portion
84: second attachment portion
85: through hole

1. An energy storage apparatus comprising:
a plurality of energy storage devices stacked and arranged in a first direction;
an end-plate disposed at each end in the first direction of the plurality of energy storage devices; and
a restraint element that is fixed to the end-plate and restrains positions in the first direction of the plurality of energy storage devices,
wherein the restraint element includes a porous member that has a plurality of cylindrical portions arranged two-dimensionally in the first direction and a second direction intersecting with the first direction and is disposed such that an axis of each of the cylindrical portions extends in a third direction intersecting with the first direction and the second directions.

2. The energy storage apparatus according to claim 1, wherein
the energy storage device comprises a flat battery including an electrode assembly and, a case in which the electrode assembly is accommodated,
the case has a pair of long side-walls extending in the second direction and the third direction, and a pair of short side-walls extending in the first direction and the second direction and each having a dimension in the first direction shorter than a dimension in the third direction of each of the long side-walls,
the restraint element has a fixing portion fixed to the end-plate, and
the porous member is disposed between at least a pair of the fixing portions.

3. The energy storage apparatus according to claim 2, wherein the cylindrical portion of the porous member has such a size that one or more of the cylindrical portions are disposed on the short side-wall of one of the cases in the first direction.

4. The energy storage apparatus according to claim 1, further comprising:
an outer case that accommodates the plurality of energy storage devices;
an electrical component disposed between at least one of a pair of the end plates and an opposedly facing surface of the outer case; and
a second porous member disposed between the electrical component and the opposedly facing surface of the outer case, having a plurality of cylindrical portions arranged two-dimensionally in the second direction and the third direction, and disposed such that an axis of each of the cylindrical portions extends in the first direction.

5. The energy storage apparatus according to claim 4, wherein
the fixing portion of the restraint element has a protrusion that protrudes from the end-plate toward the opposedly facing surface of the outer case, and
the second porous member is fixed to the protrusion.

6. The energy storage apparatus according to claim 1, wherein the cylindrical portion of the porous member has a regular hexagonal cross-section.

7. The energy storage apparatus according to claim 1, wherein
the energy storage device comprises a flat battery including an electrode assembly that has an electrode sheet, and a case in which the electrode assembly is accommodated, and
the electrode sheet has a plane extending in the second direction and the third direction.
